(19) United States
(12) Patent Application Publication
(10) Pub. No.: US 2005/0229900 A1
(43) Pub. Date: Oct. 20, 2005

(54) Combustion engine including exhaust purification with on-board ammonia production

(75) Inventors: James R. Weber, Lacon, IL (US); Scott A. Leman, Eureka, IL (US); Gerald N. Coleman, Corby (GB); Kevin P. Duffy, Metamora, IL (US); Eric C. Fluga, Dunlap, IL (US); Jonathan P. Kilkenny, Peoria, IL (US); Wade J. Robel, Peoria, IL (US); James J. Driscoll, Dunlap, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Caterpillar Inc.

(21) Appl. No.: 10/992,070

(22) Filed: Nov. 19, 2004

Related U.S. Application Data
(63) Continuation-in-part of application No. 10/933,300, filed on Sep. 3, 2004.
(63) Continuation-in-part of application No. 10/982,921, filed on Nov. 8, 2004.
Application No. 10/933,300 is a continuation-in-part of application No. 10/733,570, filed on Dec. 12, 2003.
Application No. 10/733,570 is a continuation of application No. 10/143,908, filed on May 14, 2002, now Pat. No. 6,688,280.
(63) Continuation-in-part of application No. 10/733,570, filed on Dec. 12, 2003.
Application No. 10/733,570 is a continuation of application No. 10/143,908, filed on May 14, 2002, now Pat. No. 6,688,280.

(51) Int. Cl. F02B 75/02; F02M 25/07

(52) U.S. Cl. 123/316; 123/568.14; 123/670

(57) ABSTRACT

Engines and methods of controlling an engine may include producing ammonia from exhaust gas and using the ammonia to reduce certain emission components of the exhaust. Timing of valve closing/opening and use of an air supply system may enable engine operation according to a Miller cycle.

### RELATED APPLICATIONS

This application is a continuation-in-part of U.S. patent application Ser. No. 10/933,300, filed Sep. 3, 2004, which is a continuation-in-part of U.S. patent application Ser. No. 10/733,570, filed Dec. 12, 2003, which is a continuation of U.S. patent application Ser. No. 10/143,908, filed May 14, 2002, now U.S. Pat. No. 6,688,280. This application is also a continuation-in-part of U.S. patent application Ser. No. 10/733,570, filed Dec. 12, 2003, which is a continuation of U.S. patent application Ser. No. 10/143,908, filed May 14, 2002, now U.S. Pat. No. 6,688,280. In addition, this application is a continuation-in-part of U.S. patent application Ser. No. 10/982,921, filed Nov. 8, 2004.

The entire disclosure of each of the U.S. patent applications mentioned in the preceding paragraph is incorporated herein by reference. In addition, the entire disclosure of each of U.S. Pat. No. 6,688,280 and U.S. Pat. No. 6,651,618 is incorporated herein by reference.

### U.S. GOVERNMENT RIGHTS

For some of the embodiments disclosed herein, one or more parts was made with government support under the terms of Contract No. DE-FC05-970R22605 awarded by the Department of Energy. The government may have certain rights to certain inventions disclosed herein.

### TECHNICAL FIELD

The present invention relates to a combustion engine, an air and fuel supply system for use with an internal combustion engine, and general exhaust-gas purification systems for engines, principally, selective catalytic reduction systems with on-board ammonia production.

### BACKGROUND

An internal combustion engine may include one or more turbochargers for compressing a fluid, which is supplied to one or more combustion chambers within corresponding combustion cylinders. Each turbocharger typically includes a turbine driven by exhaust gases of the engine and a compressor driven by the turbine. The compressor receives the fluid to be compressed and supplies the compressed fluid to the combustion chambers. The fluid compressed by the compressor may be in the form of combustion air or an air/fuel mixture.

An internal combustion engine may also include a supercharger arranged in series with a turbocharger compressor of an engine. U.S. Pat. No. 6,273,076 (Beck et al., issued Aug. 14, 2001) discloses a supercharger having a turbine that drives a compressor to increase the pressure of air flowing to a turbocharger compressor of an engine. In some situations, the air charge temperature may be reduced below ambient air temperature by an early closing of the intake valve.

While a turbocharger may utilize some energy from the engine exhaust, the series supercharger/turbocharger arrangement does not utilize energy from the turbocharger exhaust. Furthermore, the supercharger requires an additional energy source.

Early or late closing of the intake valve, referred to as the “Miller Cycle,” may reduce the effective compression ratio of the cylinder, which in turn reduces compression temperature, while maintaining a high expansion ratio. Consequently, a Miller cycle engine may have improved thermal efficiency and reduced exhaust emissions of, for example, oxides of Nitrogen (NOₓ). Reduced NOₓ emissions are desirable. In a conventional Miller cycle engine, the timing of the intake valve close is typically shifted slightly forward or backward from that of the typical Otto cycle engine. For example, in the Miller cycle engine, the intake valve may remain open until the beginning of the compression stroke.

Selective catalytic reduction (SCR) provides a method for removing nitrogen oxide (NOₓ) emissions from fossil fuel powered systems for engines, factories, and power plants. During SCR, a catalyst facilitates a reaction between exhaust-gas ammonia and NOₓ to produce water and nitrogen gas, thereby removing NOₓ from the exhaust gas.

The ammonia that is used for the SCR system may be produced during the operation of the NOₓ-producing system or may be stored for injection when needed. Because of the high reactivity of ammonia, storage of ammonia can be hazardous. Further, on-board production of ammonia can be costly and may require specialized equipment.

One method of on-board ammonia production for an engine is disclosed in U.S. Pat. No. 6,047,542 (Kinugasa, issued Apr. 11, 2000, hereinafter the '542 patent). The method includes the use of multiple cylinder groups for purifying exhaust gas. In the method of the '542 patent, the exhaust gas of one cylinder group may be made rich by controlling the amount of fuel injected into the cylinder group. The rich exhaust gas of this cylinder group may then be passed over to an ammonia-synthesizing catalyst to convert a portion of the NOₓ in the exhaust gas into ammonia. The exhaust gas and ammonia of the first cylinder group are then combined with the exhaust gas of a second cylinder group and passed through an SCR catalyst where the ammonia reacts with NOₓ to produce nitrogen gas and water.

While the method of the '542 patent may reduce NOₓ from an exhaust stream through use of on-board ammonia production, the method of the '542 patent has several drawbacks. For example, an engine may function less efficiently and with lower power output when rich combustion occurs in one cylinder group. Furthermore, using the method of the '542. patent, it may be more difficult to provide adequate and controlled air intake to both cylinder groups, and the two cylinder groups, operating as described in the '542 patent, may cause significant engine vibration.

The present disclosure is directed to possibly overcoming one or more of the problems or disadvantages associated with prior approaches.

### SUMMARY

In one exemplary aspect, there is a method of operating an internal combustion engine including at least one cylinder and a piston slidable in the cylinder. The method may include supplying pressurized air from an intake manifold to an air intake port of a combustion chamber in the cylinder; operating an air intake valve to open the air intake port to allow pressurized air to flow between the combustion chamber and the intake manifold substantially during a majority portion of a compression stroke of the piston; and converting at least a portion of combustion exhaust into ammonia.

Another exemplary aspect may relate to an internal combustion engine, which may include an engine block defining at least one cylinder; a head connected with said engine block, the head including an air intake port, and an exhaust port; a piston slidable in the cylinder; a combustion chamber being defined by said head, said piston, and said cylinder; an air intake valve movable to open and close the air intake port; an air supply system including at least one turbocharger fluidly connected to the air intake port; a fuel supply system operable to inject fuel into the combustion chamber; and an ammonia-producing catalyst arranged to convert at least a portion of combustion exhaust into ammonia; wherein the engine may be configured to operate the air intake valve so as to vary the closing time of the air intake valve.

A further exemplary aspect relates to a method of operating an internal combustion engine including at least one cylinder and a piston slidable in the cylinder. The method may include imparting rotational movement to a first turbine and a first compressor of a first turbocharger with exhaust air flowing from an exhaust port of the cylinder; imparting rotational movement to a second turbine and a second compressor of a second turbocharger with exhaust air flowing from an exhaust duct of the first turbocharger; compressing air drawn from atmosphere with the second compressor; compressing air received from the second compressor with the first compressor; supplying pressurized air from the first compressor to an air intake port of a combustion chamber in the cylinder via an intake manifold; operating a fuel supply system to inject fuel directly into the combustion chamber; operating an air intake valve to open the air intake port to allow pressurized air to flow between the combustion chamber and the intake manifold; and converting at least a portion of combustion exhaust into ammonia.

Yet another exemplary aspect may relate to a method of controlling an internal combustion engine having a variable compression ratio, said engine including a block defining a cylinder, a piston slidable in said cylinder, and a head connected with said block, said piston, said cylinder, and said head defining a combustion chamber. The method may include pressurizing air; supplying said air to an intake manifold of the engine; maintaining fluid communication between said combustion chamber and the intake manifold during a portion of an intake stroke and through a portion of a compression stroke; injecting fuel directly into the combustion chamber; and converting at least a portion of combustion exhaust into ammonia.

An even further aspect may relate to a method of operating an internal combustion engine including at least one cylinder and a piston slidable in the cylinder. The method may include supplying pressurized air from an intake manifold to an air intake port of a combustion chamber in the cylinder; operating an air intake valve to open the air intake port to allow pressurized air to flow between the combustion chamber and the intake manifold substantially during a portion of a compression stroke of the piston; injecting fuel into the combustion chamber after the intake valve is closed, wherein the injecting includes supplying a pilot injection of fuel at a crank angle before a main injection of fuel; and converting at least a portion of combustion exhaust into ammonia.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several exemplary embodiments of the invention and, together with the description, serve to explain the principles of the invention. In the drawings,

FIG. 1 is a combination diagrammatic and schematic illustration of an exemplary air supply system for an internal combustion engine in accordance with the invention;

FIG. 2 is a combination diagrammatic and schematic illustration of an exemplary engine cylinder in accordance with the invention;

FIG. 3 is a diagrammatic sectional view of the exemplary engine cylinder of FIG. 2;

FIG. 4 is a graph illustrating an exemplary intake valve actuation as a function of engine crank angle in accordance with the present invention;

FIG. 5 is a graph illustrating an exemplary fuel injection as a function of engine crank angle in accordance with the present invention;

FIG. 6 is a combination diagrammatic and schematic illustration of another exemplary air supply system for an internal combustion engine in accordance with the invention;

FIG. 7 is a combination diagrammatic and schematic illustration of yet another exemplary air supply system for an internal combustion engine in accordance with the invention;

FIG. 8 is a combination diagrammatic and schematic illustration of an exemplary exhaust gas recirculation system included as part of an internal combustion engine in accordance with the invention;

FIG. 9 is a schematic diagram of an engine in the form of a power source according to an exemplary disclosed embodiment;

FIG. 10 is a diagrammatic representation of first and second cylinder groups according to an exemplary disclosed embodiment;

FIG. 11 is a schematic diagram of first and second cylinder groups according to an exemplary disclosed embodiment; and

FIG. 12 is a chart of relative power outputs of multiple cylinders, as shown in FIG. 10, at three distinct times according to an exemplary embodiment.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

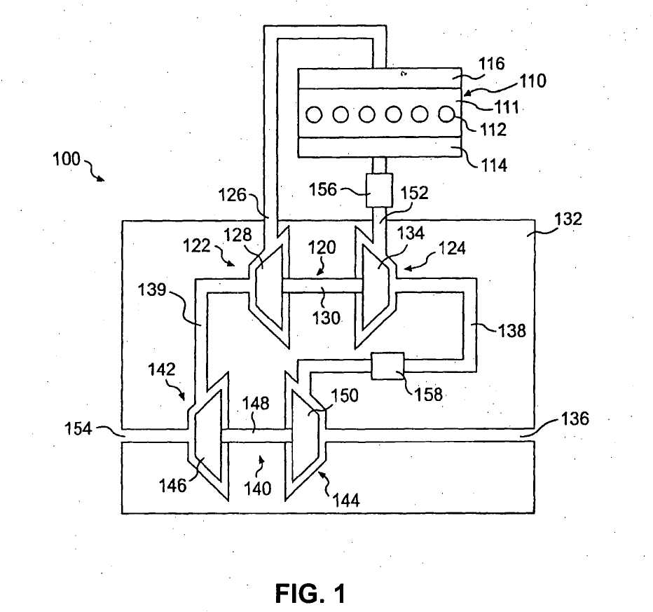

Referring to FIG. 1, an exemplary air supply system 100 for an internal combustion engine 110, for example, a four-stroke, diesel engine, is provided. The internal combustion engine 110 includes an engine block 111 defining a plurality of combustion cylinders 112, the number of which depends upon the particular application. For example, a 4-cylinder engine would include four combustion cylinders, a 6-cylinder engine would include six combustion cylinders, etc. In the exemplary embodiment of FIG. 1, six combustion cylinders 112 are shown. It should be appreciated that the engine 110 may be any other type of internal combustion engine, for example, a gasoline or natural gas engine.

The internal combustion engine 110 also includes an intake manifold 114 and an exhaust manifold 116. The intake manifold 114 provides fluid, for example, air or a fuel/air mixture, to the combustion cylinders 112. The exhaust manifold 116 receives exhaust fluid, for example, exhaust gas, from the combustion cylinders 112. The intake manifold 114 and the exhaust manifold 116 are shown as a single-part construction for simplicity in the drawing. However, it should be appreciated that the intake manifold 114 and/or the exhaust manifold 116 may be constructed as multi-part manifolds, depending upon the particular application.

The air supply system 100 includes a first turbocharger 120 and may include a second turbocharger 140. The first and second turbochargers 120, 140 may be arranged in series with one another such that the second turbocharger 140 provides a first stage of pressurization and the first turbocharger 120 provides a second stage of pressurization. For example, the second turbocharger 140 may be a low pressure turbocharger and the first turbocharger 120 may be a high pressure turbocharger. The first turbocharger 120 includes a turbine 122 and a compressor 124. The turbine 122 is fluidly connected to the exhaust manifold 116 via an exhaust duct 126. The turbine 122 includes a turbine wheel 128 carried by a shaft 130, which in turn may be rotatably carried by a housing 132, for example, a single-part or multi-part housing. The fluid flow path from the exhaust manifold 116 to the turbine 122 may include a variable nozzle (not shown) or other variable geometry arrangement adapted to control the velocity of exhaust fluid impinging on the turbine wheel 128.

The compressor 124 includes a compressor wheel 134 carried by the shaft 130. Thus, rotation of the shaft 130 by the turbine wheel 128 in turn may cause rotation of the compressor wheel 134.

The first turbocharger 120 may include a compressed air duct 138 for receiving compressed air from the second turbocharger 140 and an air outlet line 152 for receiving compressed air from the compressor 124 and supplying the compressed air to the intake manifold 114 of the engine 110. The first turbocharger 120 may also include an exhaust duct 139 for receiving exhaust fluid from the turbine 122 and supplying the exhaust fluid to the second turbocharger 140.

The second turbocharger 140 may include a turbine 142 and a compressor 144. The turbine 142 may be fluidly connected to the exhaust duct 139. The turbine 142 may include a turbine wheel 146 carried by a shaft 148, which in turn may be rotatably carried by the housing 132. The compressor 144 may include a compressor wheel 150 carried by the shaft 148. Thus, rotation of the shaft 148 by the turbine wheel 146 may in turn cause rotation of the compressor wheel 150.

The second turbocharger 140 may include an air intake line 136 providing fluid communication between the atmosphere and the compressor 144. The second turbocharger 140 may also supply compressed air to the first turbocharger 120 via the compressed air duct 138. The second turbocharger 140 may include an exhaust outlet 154 for receiving exhaust fluid from the turbine 142 and providing fluid communication with the atmosphere. In an embodiment, the first turbocharger 120 and second turbocharger 140 may be sized to provide substantially similar compression ratios. For example, the first turbocharger 120 and second turbocharger 140 may both provide compression ratios of between 2 to 1 and 3 to 1, resulting in a system compression ratio of at least 4 to 1 with respect to atmospheric pressure. Alternatively, the second turbocharger 140 may provide a compression ratio of 3 to 1 and the first turbocharger 120 may provide a compression ratio of 1.5 to 1, resulting in a system compression ratio of 4.5 to 1 with respect to atmospheric pressure.

The air supply system 100 may include an air cooler 156, for example, an aftercooler, between the compressor 124 and the intake manifold 114. The air cooler 156 may extract heat from the air to lower the intake manifold temperature and increase the air density. Optionally, the air supply system 100 may include an additional air cooler 158, for example, an intercooler, between the compressor 144 of the second turbocharger 140 and the compressor 124 of the first turbocharger 120. Intercooling may use techniques such as jacket water, air to air, and the like. Alternatively, the air supply system 100 may optionally include an additional air cooler (not shown) between the air cooler 156 and the intake manifold 114. The optional additional air cooler may further reduce the intake manifold temperature. A jacket water pre-cooler (not shown) may be used to protect the air cooler 156.

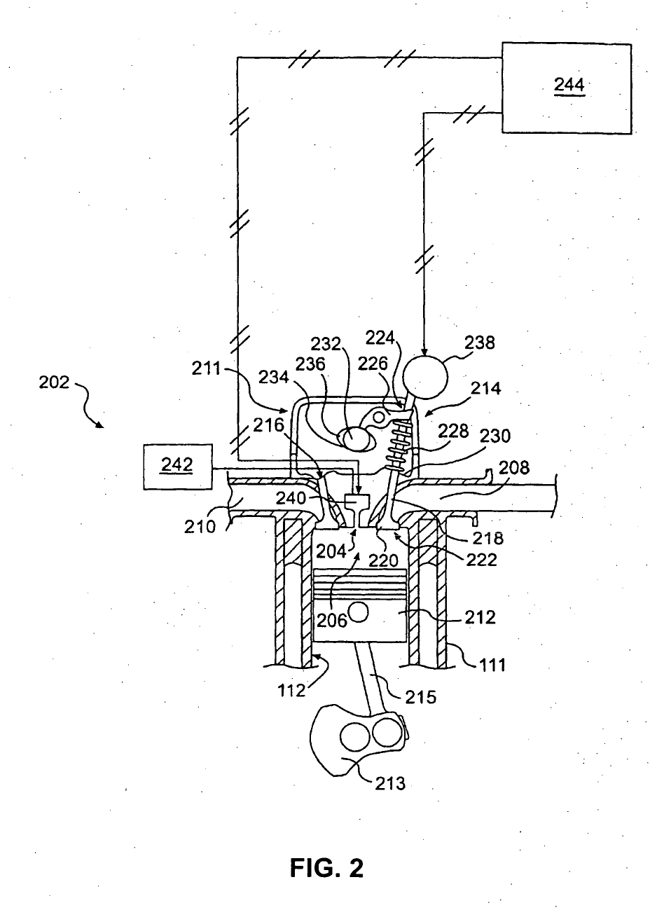

Referring now to FIG. 2, a cylinder head 211 may be connected with the engine block 111. Each cylinder 112 in the cylinder head 211 may be provided with a fuel supply system 202. The fuel supply system 202 may include a fuel port 204 opening to a combustion chamber 206 within the cylinder 112. The fuel supply system 202 may inject fuel, for example, diesel fuel, directly into the combustion chamber 206.

The cylinder 112 may contain a piston 212 slidably movable in the cylinder. A crankshaft 213 may be rotatably disposed within the engine block 111. A connecting rod 215 may couple the piston 212 to the crankshaft 213 so that sliding motion of the piston 212 within the cylinder 112 results in rotation of the crankshaft 213. Similarly, rotation of the crankshaft 213 results in a sliding motion of the piston 212. For example, an uppermost position of the piston 212 in the cylinder 112 corresponds to a top dead center position of the crankshaft 213, and a lowermost position of the piston 212 in the cylinder 112 corresponds to a bottom dead center position of the crankshaft 213.

As one skilled in the art will recognize, the piston 212 in a conventional, four-stroke engine cycle reciprocates between the uppermost position and the lowermost position during a combustion (or expansion) stroke, an exhaust stroke, and intake stroke, and a compression stroke. Meanwhile, the crankshaft 213 rotates from the top dead center position to the bottom dead center position during the combustion stroke, from the bottom dead center to the top dead center during the exhaust stroke, from top dead center to bottom dead center during the intake stroke, and from bottom dead center to top dead center during the compression stroke. Then, the four-stroke cycle begins again. Each piston stroke correlates to about 180° of crankshaft rotation, or crank angle. Thus, the combustion stroke may begin at about 0° crank angle, the exhaust stroke at about 180°, the intake stroke at about 360°, and the compression stroke at about 540°.

The cylinder 112 may include at least one intake port 208 and at least one exhaust port 210, each opening to the combustion chamber 206. The intake port 208 may be opened and closed by an intake valve assembly 214, and the exhaust port 210 may be opened and closed by an exhaust valve assembly 216. The intake valve assembly 214 may include, for example, an intake valve 218 having a head 220 at a first end 222, with the head 220 being sized and arranged to selectively close the intake port 208. The second end 224 of the intake valve 218 may be connected to a rocker arm 226 or any other conventional valve-actuating mechanism. The intake valve 218 may be movable between a first position permitting flow from the intake manifold 114 to enter the combustion cylinder 112 and a second position substantially blocking flow from the intake manifold 114 to the combustion cylinder 112. A spring 228 may be disposed about the intake valve 218 to bias the intake valve 218 to the second, closed position.

A camshaft 232 carrying a cam 234 with one or more lobes 236 may be arranged to operate the intake valve assembly 214 cyclically based on the configuration of the cam 234, the lobes 236, and the rotation of the camshaft 232 to achieve a desired intake valve timing. The exhaust valve assembly 216 may be configured in a manner similar to the intake valve assembly 214 and may be operated by one of the lobes 236 of the cam 234. In an embodiment, the intake lobe 236 may be configured to operate the intake valve 218 in a conventional Otto or diesel cycle, whereby the intake valve 218 moves to the second position from between about 10° before bottom dead center of the intake stroke and about 10° after bottom dead center of the compression stroke. Additionally, the intake valve assembly 214 and/or the exhaust valve assembly 216 may be operated hydraulically, pneumatically, electronically, or by any combination of mechanics, hydraulics, pneumatics, and/or electronics.

The intake valve assembly 214 may include a variable intake valve closing mechanism 238 structured and arranged to selectively interrupt cyclical movement of and extend the closing timing of the intake valve 218. The variable intake valve closing mechanism 238 may be operated hydraulically, pneumatically, electronically, mechanically, or any combination thereof. For example, the variable intake valve closing mechanism 238 may be selectively operated to supply hydraulic fluid, for example, at a low pressure or a high pressure, in a manner to resist closing of the intake valve 218 by the bias of the spring 228. That is, after the intake valve 218 is lifted, i.e., opened, by the cam 234, and when the cam 234 is no longer holding the intake valve 218 open, the hydraulic fluid may hold the intake valve 218 open for a desired period. The desired period may change depending on the desired performance of the engine 110. Thus, the variable intake valve closing mechanism 238 enables the engine 110 to operate under a conventional Otto or diesel cycle or under a variable late-closing Miller cycle.

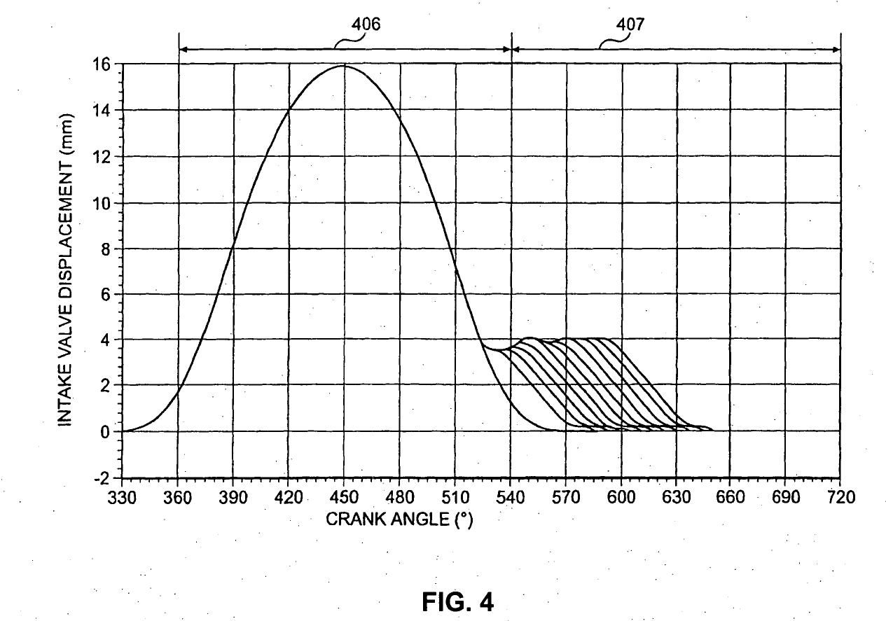

As shown in FIG. 4, the intake valve 218 may begin to open at about 360° crank angle, that is, when the crankshaft 213 is at or near a top dead center position of an intake stroke 406. The closing of the intake valve 218 may be selectively varied from about 540° crank angle, that is, when the crank shaft is at or near a bottom dead center position of a compression stroke 407, to about 650° crank angle, that is, about 70° before top center of the combustion stroke 508. Thus, the intake valve 218 may be held open for more than half of the compression stroke 407, that is, for the first half of the compression stroke 407 and a portion of the second half of the compression stroke 407.

The fuel supply system 202 may include a fuel injector assembly 240, for example, a mechanically-actuated, electronically-controlled unit injector, in fluid communication with a common fuel rail 242. Alternatively, the fuel injector assembly 240 may be any common rail type injector and may be actuated and/or operated hydraulically, mechanically, electrically, piezo-electrically, or any combination thereof. The common fuel rail 242 provides fuel to the fuel injector assembly 240 associated with each cylinder 112. The fuel injector assembly 240 may inject or otherwise spray fuel into the cylinder 112 via the fuel port 204 in accordance with a desired timing.

A controller 244 may be electrically connected to the variable intake valve closing mechanism 238 and/or the fuel injector assembly 240. The controller 244 may be configured to control operation of the variable intake valve closing mechanism 238 and/or the fuel injector assembly 240 based on one or more engine conditions, for example, engine speed, load, pressure, and/or temperature in order to achieve a desired engine performance. It should be appreciated that the functions of the controller 244 may be performed by a single controller or by a plurality of controllers. Similarly, spark timing in a natural gas engine may provide a similar function to fuel injector timing of a compression ignition engine.

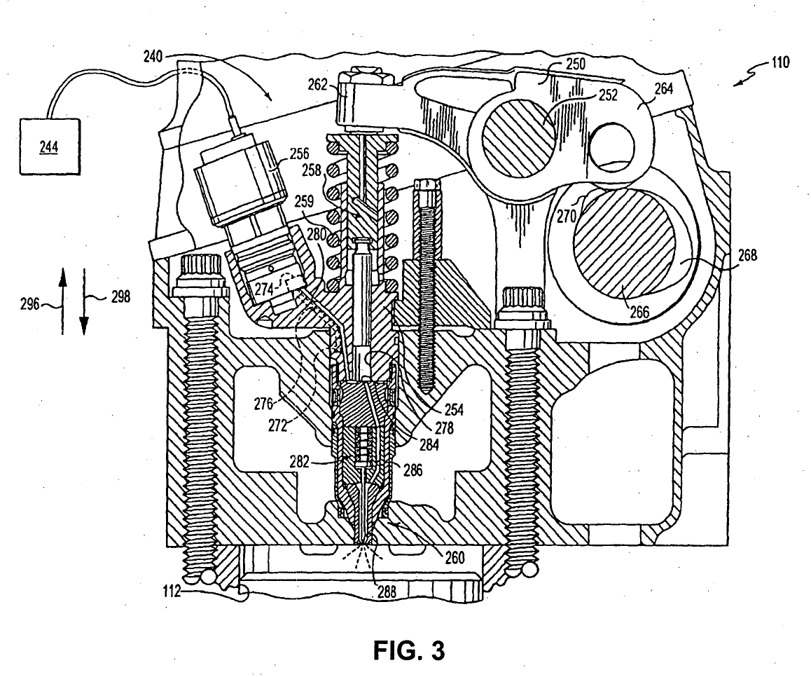

Referring now to FIG. 3, each fuel injector assembly 240 may be associated with an injector rocker arm 250 pivotally coupled to a rocker shaft 252. Each fuel injector assembly 240 may include an injector body 254, a solenoid 256, a plunger assembly 258, and an injector tip assembly 260. A first end 262 of the injector rocker arm 250 may be operatively coupled to the plunger assembly 258. The plunger assembly 258 may be biased by a spring 259 toward the first end 262 of the injector rocker arm 250 in the general direction of arrow 296.

A second end 264 of the injector rocker arm 250 may be operatively coupled to a camshaft 266. More specifically, the camshaft 266 may include a cam lobe 267 having a first bump 268 and a second bump 270. The camshafts 232, 266 and their respective lobes 236, 267 may be combined into a single camshaft (not shown) if desired. The bumps 268, 270 may be moved into and out of contact with the second end 264 of the injector rocker arm 250 during rotation of the camshaft 266. The bumps 268, 270 may be structured and arranged such that the second bump 270 may provide a pilot injection of fuel at a predetermined crank angle before the first bump 268 provides a main injection of fuel. It should be appreciated that the cam lobe 267 may have only a first bump 268 that injects all of the fuel per cycle.

When one of the bumps 268, 270 is rotated into contact with the injector rocker arm 250, the second end 264 of the injector rocker arm 250 is urged in the general direction of arrow 296. As the second end 264 is urged in the general direction of arrow 296, the rocker arm 250 pivots about the rocker shaft 252 thereby causing the first end 262 to be urged in the general direction of arrow 298. The force exerted on the second end 264 by the bumps 268, 270 is greater in magnitude than the bias generated by the spring 259, thereby causing the plunger assembly 258 to be likewise urged in the general direction of arrow 298. When the camshaft 266 is rotated beyond the maximum height of the bumps 268, 270, the bias of the spring 259 urges the plunger assembly 258 in the general direction of arrow 296. As the plunger assembly 258 is urged in the general direction of arrow 296, the first end 262 of the injector rocker arm 250 is likewise urged in the general direction of arrow 296, which causes the injector rocker arm 250 to pivot about the rocker shaft 252 thereby causing the second end 264 to be urged in the general direction of arrow 298.

The injector body 254 defines a fuel port 272. Fuel, such as diesel fuel, may be drawn or otherwise aspirated into the fuel port 272 from the fuel rail 242 when the plunger assembly 258 is moved in the general direction of arrow 296. The fuel port 272 is in fluid communication with a fuel valve 274 via a first fuel channel 276. The fuel valve 274 is, in turn in fluid communication with a plunger chamber 278 via a second fuel channel 280.

The solenoid 256 may be electrically coupled to the controller 244 and mechanically coupled to the fuel valve 274. Actuation of the solenoid 256 by a signal from the controller 244 may cause the fuel valve 274 to be switched from an open position to a closed position. When the fuel valve 274 is positioned in its open position, fuel may advance from the fuel port 272 to the plunger chamber 278, and vice versa. However, when the fuel valve 274 is positioned in its closed positioned, the fuel port 272 is isolated from the plunger chamber 278.

The injector tip assembly 260 may include a check valve assembly 282. Fuel may be advanced from the plunger chamber 278, through an inlet orifice 284, a third fuel channel 286, an outlet orifice 288, and into the cylinder 112 of the engine 110.

Thus, it should be appreciated that when one of the bumps 268, 270 is not in contact with the injector rocker arm 16, the plunger assembly 258 is urged in the general direction of arrow 296 by the spring 259 thereby causing fuel to be drawn into the fuel port 272 which in turn fills the plunger chamber 278 with fuel. As the camshaft 266 is further rotated, one of the bumps 268, 270 is moved into contact with the rocker arm 250, thereby causing the plunger assembly 258 to be urged in the general direction of arrow 298. If the controller 244 is not generating an injection signal, the fuel valve 274 remains in its open position, thereby causing the fuel which is in the plunger chamber 278 to be displaced by the plunger assembly 258 through the fuel port 272. However, if the controller 244 is generating an injection signal, the fuel valve 274 is positioned in its closed position thereby isolating the plunger chamber 278 from the fuel port 272. As the plunger assembly 258 continues to be urged in the general direction of arrow 298 by the camshaft 266, fluid pressure within the fuel injector assembly 240 increases. At a predetermined pressure magnitude, for example, at about 5500 psi (38 MPa), fuel is injected into the cylinder 112. Fuel will continue to be injected into the cylinder 112 until the controller 244 signals the solenoid 256 to return the fuel valve 274 to its open position.

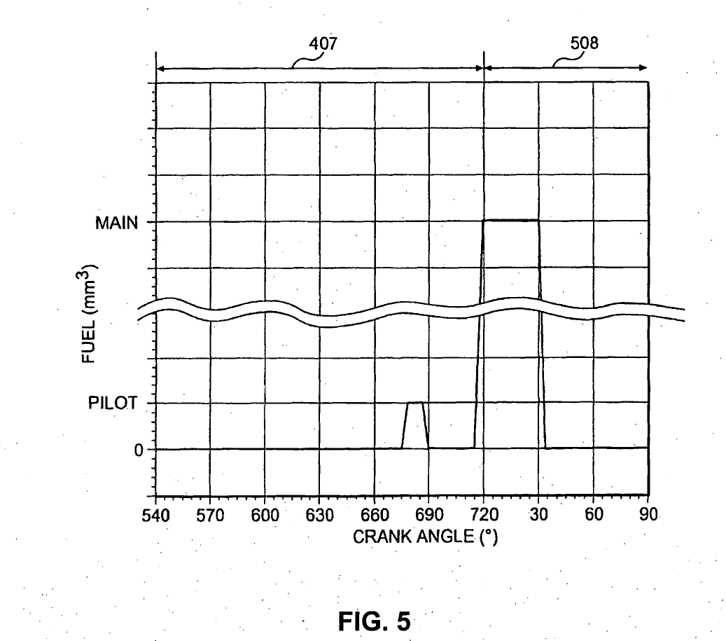

As shown in the exemplary graph of FIG. 5, the pilot injection of fuel may commence when the crankshaft 213 is at about 675° crank angle, that is, about 45° before top dead center of the compression stroke 407. The main injection of fuel may occur when the crankshaft 213 is at about 710° crank angle, that is, about 10° before top dead center of the compression stroke 407 and about 45° after commencement of the pilot injection. Generally, the pilot injection may commence when the crankshaft 213 is about 40-50° before top dead center of the compression stroke 407 and may last for about 10-15° crankshaft rotation. The main injection may commence when the crankshaft 213 is between about 10° before top dead center of the compression stroke 407 and about 12° after top dead center of the combustion stroke 508. The main injection may last for about 20-45° crankshaft rotation. The pilot injection may use a desired portion of the total fuel used, for example about 10%.

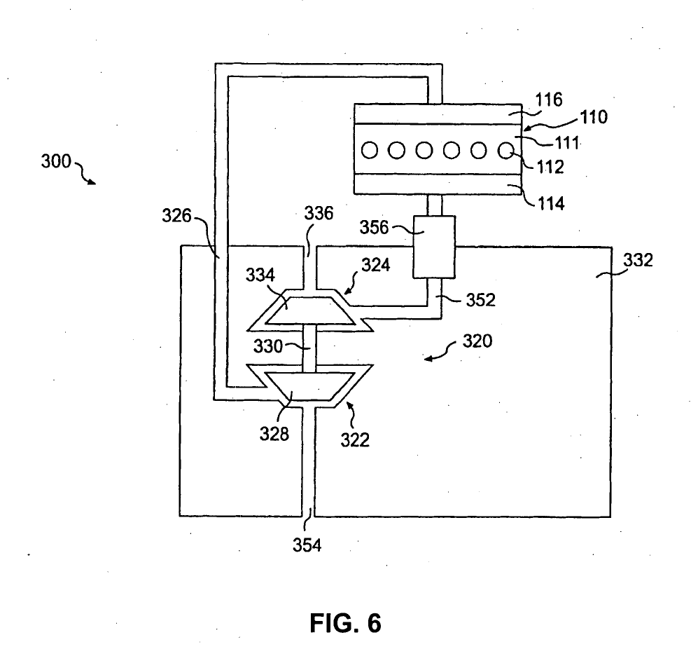

FIG. 6 is a combination diagrammatic and schematic illustration of an alternative exemplary air supply system 300 for the internal combustion engine 110. The air supply system 300 may include a turbocharger 320, for example, a high-efficiency turbocharger capable of producing at least about a 4 to 1 compression ratio with respect to atmospheric pressure. The turbocharger 320 may include a turbine 322 and a compressor 324. The turbine 322 may be fluidly connected to the exhaust manifold 116 via an exhaust duct 326. The turbine 322 may include a turbine wheel 328 carried by a shaft 330, which in turn may be rotatably carried by a housing 332, for example, a single-part or multi-part housing. The fluid flow path from the exhaust manifold 116 to the turbine 322 may include a variable nozzle (not shown), which may control the velocity of exhaust fluid impinging on the turbine wheel 328.

The compressor 324 may include a compressor wheel 334 carried by the shaft 330. Thus, rotation of the shaft 330 by the turbine wheel 328 in turn may cause rotation of the compressor wheel 334. The turbocharger 320 may include an air inlet 336 providing fluid communication between the atmosphere and the compressor 324 and an air outlet 352 for supplying compressed air to the intake manifold 114 of the engine 110. The turbocharger 320 may also include an exhaust outlet 354 for receiving exhaust fluid from the turbine 322 and providing fluid communication with the atmosphere.

The air supply system 300 may include an air cooler 356 between the compressor 324 and the intake manifold 114. Optionally, the air supply system 300 may include an additional air cooler (not shown) between the air cooler 356 and the intake. manifold 114.

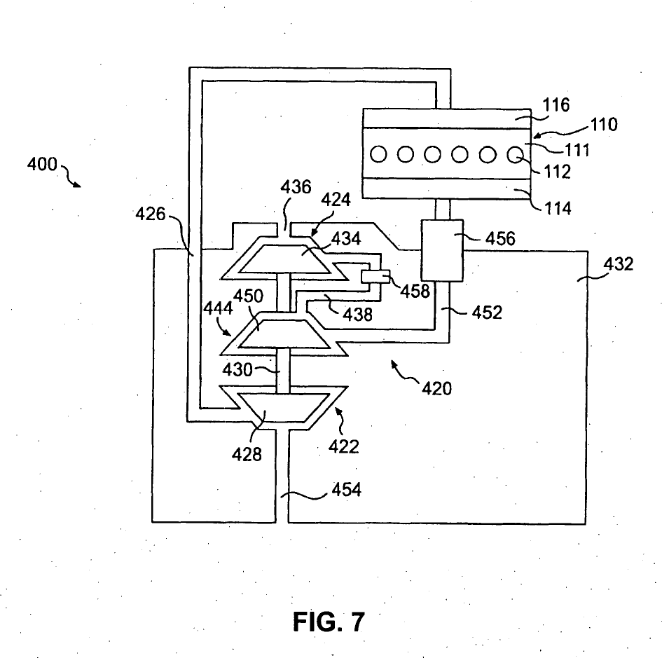

FIG. 7 is a combination diagrammatic and schematic illustration of another alternative exemplary air supply system 400 for the internal combustion engine 110. The air supply system 400 may include a turbocharger 420, for example, a turbocharger 420 having a turbine 422 and two compressors 424, 444. The turbine 422 may be fluidly connected to the exhaust manifold 116 via an inlet duct 426. The turbine 422 may include a turbine wheel 428 carried by a shaft 430, which in turn may be rotatably carried by a housing 432, for example, a single-part or multi-part housing. The fluid flow path from the exhaust manifold 116 to the turbine 422 may include a variable nozzle (not shown), which may control the velocity of exhaust fluid impinging on the turbine wheel 428.

The first compressor 424 may include a compressor wheel 434 carried by the shaft 430, and the second compressor 444 may include a compressor wheel 450 carried by the shaft 430. Thus, rotation of the shaft 430 by the turbine wheel 428 in turn may cause rotation of the first and second compressor wheels 434, 450. The first and second compressors 424, 444 may provide first and second stages of pressurization, respectively.

The turbocharger 420 may include an air intake line 436 providing fluid communication between the atmosphere and the first compressor 424 and a compressed air duct 438 for receiving compressed air from the first compressor 424 and supplying the compressed air to the second compressor 444. The turbocharger 420 may include an air outlet line 452 for supplying compressed air from the second compressor 444 to the intake manifold 114 of the engine 110. The turbocharger 420 may also include an exhaust outlet 454 for receiving exhaust fluid from the turbine 422 and providing fluid communication with the atmosphere.

For example, the first compressor 424 and second compressor 444 may both provide compression ratios of between 2 to 1 and 3 to 1, resulting in a system compression ratio of at least 4 to 1 with respect to atmospheric pressure. Alternatively, the second compressor 444 may provide a compression ratio of 3 to 1 and the first compressor 424 may provide a compression ratio of 1.5 to 1, resulting in a system compression ratio of 4.5 to 1 with respect to atmospheric pressure.

The air supply system 400 may include an air cooler 456 between the compressor 424 and the intake manifold 114. Optionally, the air supply system 400 may include an additional air cooler 458 between the first compressor 424 and the second compressor 444 of the turbocharger 420. Alternatively, the air supply system 400 may optionally include an additional air cooler (not shown) between the air cooler 456 and the intake manifold 114.

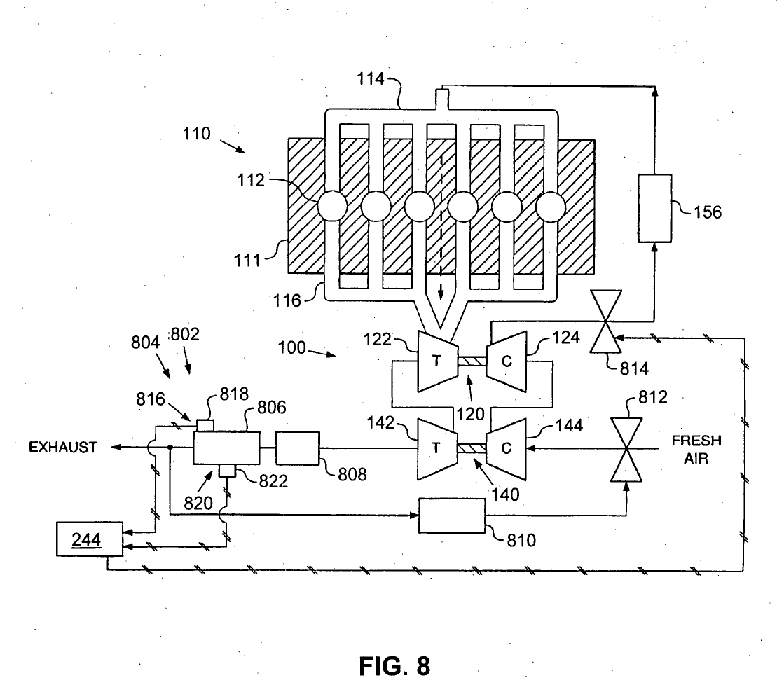

FIG. 8 shows an exemplary exhaust gas recirculation (EGR) system 804 in an exhaust system 802 of combustion engine 110. Combustion engine 110 includes intake manifold 114 and exhaust manifold 116. Engine block 111 provides housing for at least one cylinder 112. FIG. 8 depicts six cylinders 112; however, any number of cylinders 112 could be used, for example, three, six, eight, ten, twelve, or any other number. The intake manifold 114 provides an intake path for each cylinder 112 for air, recirculated exhaust gases, or a combination thereof. The exhaust manifold 116 provides an exhaust path for each cylinder 112 for exhaust gases.

In the embodiment shown in FIG. 8, the air supply system 100 is shown as a two-stage turbocharger system. Air supply system 100 includes first turbocharger 120 having turbine 122 and compressor 124. Air supply system 100 also includes second turbocharger 140 having turbine 142 and compressor 144. The two-stage turbocharger system operates to increase the pressure of the air and exhaust gases being delivered to the cylinders 112 via intake manifold 114, and to maintain a desired air to fuel ratio during extended open durations of intake valves. It is noted that a two-stage turbocharger system is not required for operation of the present invention. Other types of turbocharger systems, such as a high pressure ratio single-stage turbocharger system, a variable geometry turbocharger system, and the like, may be used instead. Alternatively, one or more superchargers or other types of compressors may be used.

A throttle valve 814, located between compressor 124 and intake manifold 114, may be used to control the amount of air and recirculated exhaust gases being delivered to the cylinders 112. The throttle valve 814 is shown between compressor 124 and an aftercooler 156. However, the throttle valve 814 may be positioned at other locations, such as after aftercooler 156. Operation of the throttle valve 814 is described in more detail below.

The EGR system 804 shown in FIG. 8 is typical of a low pressure EGR system in an internal combustion engine. Alternatively, variations of the EGR system 804 may be used, including both low pressure loop and high pressure loop EGR systems. Other types of EGR systems, such as for example by-pass, venturi, piston-pumped, peak clipping, and back pressure, could be used.

An oxidation catalyst 808 receives exhaust gases from turbine 142, and serves to reduce HC emissions. The oxidation catalyst 808 may also be coupled with a De-NOₓ, catalyst to further reduce NOₓ, emissions. A particulate matter (PM) filter 806 receives exhaust gases from oxidation catalyst 808. Although oxidation catalyst 808 and PM filter 806 are shown as separate items, they may alternatively be combined into one package.

Some of the exhaust gases are delivered out the exhaust from the PM filter 806. However, a portion of exhaust gases are rerouted to the intake manifold 114 through an EGR cooler 810, through an EGR valve 812, and through first and second turbochargers 120,140. EGR cooler 810 may be of a type well known in the art, for example a jacket water or an air to gas heat exchanger type.

A means 816 for determining pressure within the PM filter 806 is shown. In one embodiment, the means 816 for determining pressure includes a pressure sensor 818. However, other alternate means 816 may be employed. For example, the pressure of the exhaust gases in the PM filter 806 may be estimated from a model based on one or more parameters associated with the engine 110. Parameters may include, but are not limited to, engine load, engine speed, temperature, fuel usage, and the like.

A means 820 for determining flow of exhaust gases through the PM filter 806 may be used. The means 820 for determining flow of exhaust gases may include a flow sensor 822. The flow sensor 822 may be used alone to determine pressure in the PM filter 806 based on changes in flow of exhaust gases, or may be used in conjunction with the pressure sensor 818 to provide more accurate pressure change determinations.

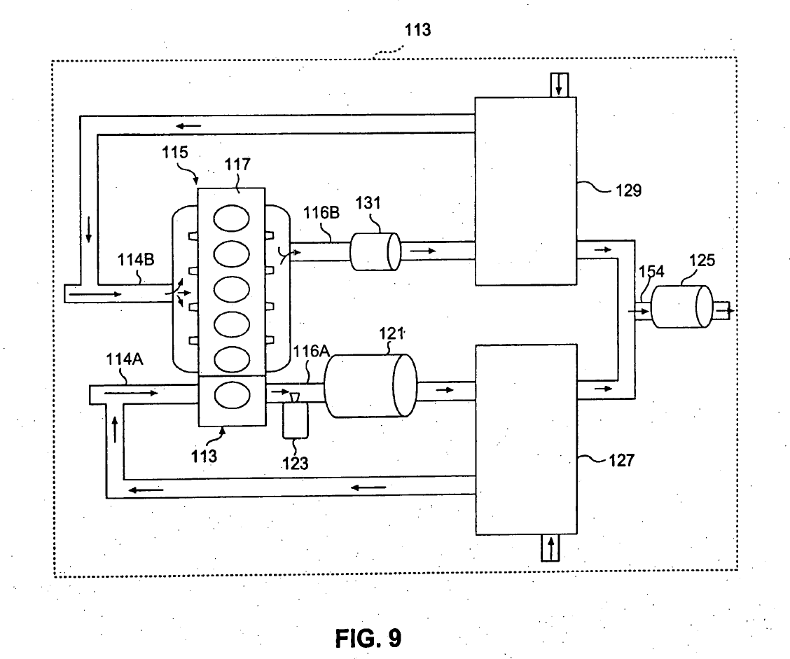

FIG. 9 provides a schematic representation of a work machine 113 of the present disclosure including an internal combustion engine in the form of a power source 115. Power source 115 may include a first cylinder group 113 and a second cylinder group 117. Each cylinder in the cylinder groups 113 and 117 may be configured in the form of the engine cylinder arrangement shown in FIG. 2 and operate in a manner as discussed herein in connection with FIG. 2. (Other arrangements are possible.) First cylinder group 113 may fluidly communicate with a first air-intake passage 114A and a first exhaust passage 116A. Second cylinder group 117 may fluidly communicate with a second air-intake passage 114B and a second exhaust passage 116B. In one embodiment, first air-intake passage 114A is fluidly isolated from second air-intake passage 114B.

The operation of engine cylinders may be dependant on the ratio of air to fuel-vapor that is injected into the cylinders during operation. The air to fuel-vapor ratio is often expressed as a lambda value, which is derived from the stoichiometric air to fuel-vapor ratio. The stoichiometric air to fuel-vapor ratio is the chemically correct ratio for combustion to take place. A stoichiometric air to fuel-vapor ratio may be considered to be equivalent to a lambda value of 1.0.

Engine cylinders may operate at non-stoichiometric air to fuel-vapor ratios. An engine cylinder with a lower air to fuel-vapor ratio has a lambda less than 1.0 and is said to be rich. An engine cylinder with a higher air to fuel-vapor ratio has a lambda greater than 1.0 and is said to be lean.

Lambda may affect cylinder NOₓ emissions and fuel efficiency. A lean-operating cylinder may have improved fuel efficiency compared to a cylinder operating under stoichiometric or rich conditions. However, lean operation may increase NOₓ production or may make elimination of NOₓ in the exhaust gas difficult.

SCR systems provide a method for decreasing exhaust-gas NOₓ emissions through the use of ammonia. In an exemplary embodiment of the present disclosure, engine NOₓ generated by lean combustion in first cylinder group 113 may be converted into ammonia. This ammonia may be used with an SCR system to remove NOₓ produced as a byproduct of fuel combustion in power source 115.

In one embodiment, power source 115 of the present disclosure may include an ammonia-producing catalyst 121 that may be configured to convert at least a portion of the exhaust-gas stream from first cylinder group 113 into ammonia. This ammonia may be produced by a reaction between NOₓ and other substances in the exhaust-gas stream from first cylinder group 113. For example, NOₓ may react with a variety of other combustion byproducts to produce ammonia. These other combustion byproducts may include, for example, H₂ (hydrogen gas), C₃H₆ (propene), or CO (carbon monoxide).

Ammonia-producing catalyst 121 may be made from a variety of materials. In one embodiment, ammonia-producing catalyst 121 may include at least one of platinum, palladium, rhodium, iridium, copper, chrome, vanadium, titanium, iron, or cesium. Combinations of these materials may be used, and the catalyst material may be chosen based on the type of fuel used, the air to fuel-vapor ratio desired, or for conformity with environmental standards.

Lean operation of first cylinder group 113 may allow increased NOₓ production as compared to stoichiometric or rich operation of first cylinder group 113. Further, the efficiency of conversion of NOₓ to ammonia by ammonia-producing catalyst 121 may be improved under rich conditions. Therefore, to increase ammonia production, engine cylinders may be operated under lean conditions in order to produce a NOₓ-containing exhaust gas, and fuel may be supplied to this NOₓ-containing exhaust gas to produce a rich, NOₓ-containing exhaust gas that can be used to produce ammonia by ammonia-producing catalyst 121.

First cylinder group 113 may include one or more cylinders, and second cylinder group 117 may include at least two cylinders. For example, first cylinder group 113 may include between one and ten cylinders, and second cylinder group 117 may include between two and twelve cylinders. In one embodiment, first cylinder group 113 may include only one cylinder, and second cylinder group 117 may include five cylinders. In another embodiment, first cylinder group 113 may include one cylinder, and second cylinder group 117 may include seven cylinders. In another embodiment, first cylinder group 113 may include one cylinder, and second cylinder group 117 may include eleven cylinders. The number of cylinders in first cylinder group 113 and the number of cylinders in second cylinder group 117 may be selected based on a desired power output to be produced by power source 115.

In one embodiment, first cylinder group 113 may operate with a lean air-to-fuel ratio within the one or more cylinders of first cylinder group 113. The one or more cylinders of first cylinder group 113, operating with a lean air to fuel-vapor ratio, may produce a lean exhaust-gas stream that contains NOₓ. The lean, NOₓ-containing exhaust-gas stream may flow into first exhaust passage 116A, which may be fluidly connected with the one or more cylinders of first cylinder group 113.

In order to produce the rich conditions that favor conversion of NOₓ to ammonia, a fuel-supply device 123 may be configured to supply fuel into first exhaust passage 116A. In one embodiment, a lean, NOₓ-containing exhaust-gas stream may be delivered to first exhaust passage 116A, and fuel-supply device 123 may be configured to supply fuel into first exhaust passage 116A, thereby making the exhaust-gas stream rich. The exhaust-gas stream in first exhaust passage 116A may be lean upstream of fuel-supply device 123 and rich downstream of fuel-supply device 123.

First exhaust passage 116A may fluidly communicate with second exhaust passage 116B at a point downstream of fuel-supply device 123 to form a merged exhaust passage 154. Merged exhaust passage 154 may contain a mixture of an exhaust-gas stream produced by second cylinder group 117 and an ammonia-containing, exhaust-gas stream produced by ammonia-producing catalyst 121 in first exhaust passage 116A.

A NOₓ-reducing catalyst 125 may be disposed in merged exhaust passage 154. In one embodiment, NOₓ-reducing catalyst 125 may facilitate a reaction between ammonia and NOₓ to at least partially remove NOₓ from the exhaust-gas stream in merged exhaust passage 154. For example, NOₓ-reducing catalyst 125 may facilitate a reaction between ammonia and NOₓ to produce nitrogen gas and water, among other reaction products.

Power source 115 may include forced-induction systems to increase power output and/or control the air to fuel-vapor ratios within the cylinders of first cylinder group 113 or second cylinder group 117. Forced-induction systems may include, for example, turbochargers and/or superchargers. In one embodiment, a first forced-induction system 127 may be operably connected with first air-intake passage 114A, and a second forced-induction system 129 may be operably connected with second air-intake passage 114B.

For example, the first forced-induction system 127 and/or second forced-induction system 129 may be a turbocharger. The turbocharger may utilize the exhaust gas in first exhaust passage 116A or second exhaust passage 116B to generate power for a compressor, and this compressor may provide additional air to first air-intake passage 114A or second air-intake passage 114B. Therefore, if first forced-induction system 127 or second forced-induction system 129 is a turbocharger, the turbocharger may be operably connected with both an exhaust passage and an air-intake passage, as shown in FIG. 9.

In some embodiments, the forced-induction systems 127 and 129 may include one or more features (e.g., turbocharger arrangements) described herein in connection with the air supply systems 100, 300, and 400.

In another embodiment, first forced-induction system 127 may be a turbocharger, and ammonia-producing catalyst 121 may be positioned downstream of first forced-induction system 127. The exhaust stream in first exhaust passage 116A may be cooler downstream of first forced-induction system 127 than upstream of first forced-induction system 127. Ammonia-producing catalyst 121 may function more efficiently when exposed to a cooler exhaust-gas downstream of first forced-induction system 127.

In yet another embodiment, first forced-induction system 127 or second forced-induction system 129 may be a supercharger. A supercharger may derive its power from a belt that connects directly to an engine. Further, superchargers do not need to be connected with an exhaust stream. Therefore, if first forced-induction system 127 or second forced-induction system 129 is a supercharger, the supercharger may be operably connected with first air-intake passage 114A or second air-intake passage 114B, but the supercharger will not be operably connected with first exhaust passage 116A or second exhaust passage 116B.

In an alternative embodiment, first air-intake passage 114A or second air-intake passage 114B may be naturally aspirated. A naturally aspirated air-intake passage may include no forced-induction system. Alternatively, an air-intake passage may include a forced-induction system, but the forced-induction system may be turned on and off based on demand. For example, when increased airflow is needed, first forced-induction system 127 or second forced-induction system 129 may be turned on to supply additional air to first air-intake passage 114A and/or second air-intake passage 114B. When lower air-intake is needed, such as when little power is needed from power source 115, first air-intake passage 114A and/or second air intake passage 114B may be naturally aspirated. In one embodiment, second air-intake passage 114B may be operably connected with second forced-induction system 129, and first air-intake passage 114A may be naturally aspirated.

The embodiment of FIG. 9 has a second exhaust passage 116B which includes an oxidation catalyst 131. NOₓ may include several oxides of nitrogen including nitric oxide (NO) and nitrogen dioxide (NO₂), and NOₓ-reducing catalyst 125 may function most effectively with a ratio of NO:NO₂ of about 1:1. Oxidation catalyst 131 may be configured to control a ratio of NO:NO₂ in second exhaust passage 116B. Further, by controlling a ratio of NO:NO₂ in second exhaust passage 116B, oxidation catalyst 131 may also be configured to control a ratio of NO:NO₂ in merged exhaust passage 154.

A variety of additional catalysts and/or filters may be included in first-exhaust passage 116A and/or second-exhaust passage 116B. These catalysts and filters may include particulate filters, NOₓ traps, and/or three-way catalysts. In one embodiment, first-exhaust passage 116A and/or second-exhaust passage 116B may include, for example, one or more diesel particulate filters.

In one embodiment of the present disclosure, the power outputs of the one or more cylinders of first cylinder group 113 may be different than the power outputs of the cylinders of second cylinder group 117. To avoid potential vibration that may result from unbalanced cylinder operation, the stroke cycles of one or more cylinders of first cylinder group 113 may be matched with the stroke cycles of one or more cylinders of second cylinder group 117.

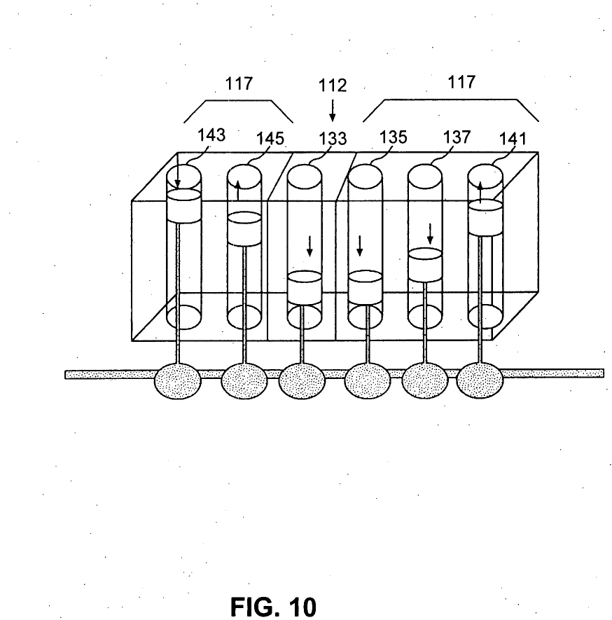

In one embodiment shown in FIG. 10, the stroke cycle of one or more cylinders of first cylinder group 113 may be matched with the stroke cycle of one or more cylinders of second cylinder group 117. In this embodiment, first cylinder group 113 includes only a single cylinder 133, and second cylinder group 117 includes five cylinders, including a cylinder 135 and all other cylinders 137, 141, 143, 145 of second cylinder group 117. Further, single cylinder 133 of first cylinder group 113 has a stroke cycle that is matched with the stroke cycle of cylinder 135 of second cylinder group 117. All the other cylinders 137, 141, 143, 145 of the second cylinder group 117 may have unique stroke cycles.

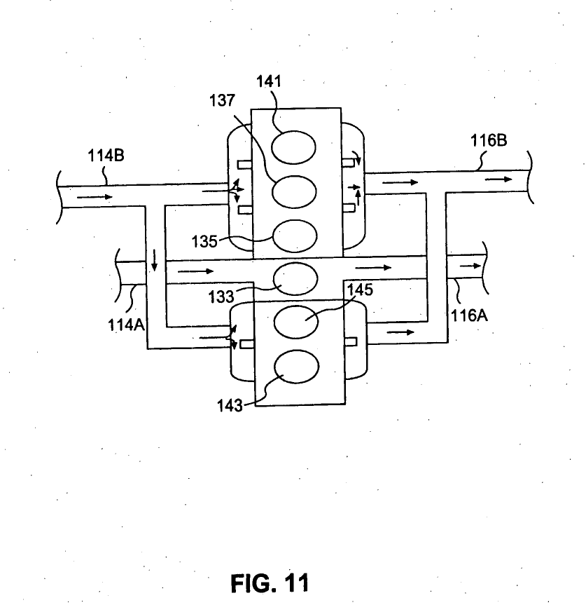

FIG. 11 illustrates the fluid communications of air-intake passages and exhaust passages with the cylinders of FIG. 10. In this embodiment, first air-intake passage 114A and first exhaust passage 116A may fluidly communicate with a single cylinder 133 of first cylinder group 113. Further, second air-intake passage 114B may fluidly communicate with cylinder 135 of second cylinder group 117, as well as all the other cylinders 137, 141, 143, 145 of second cylinder group 117, and second air-intake passage 114B may be fluidly isolated from first air-intake passage 114A. In addition, second exhaust passage 116B may fluidly communicate with cylinder 135 of second cylinder group 117, as well as all the other cylinders 137, 141, 143, 145 of second cylinder group 117.

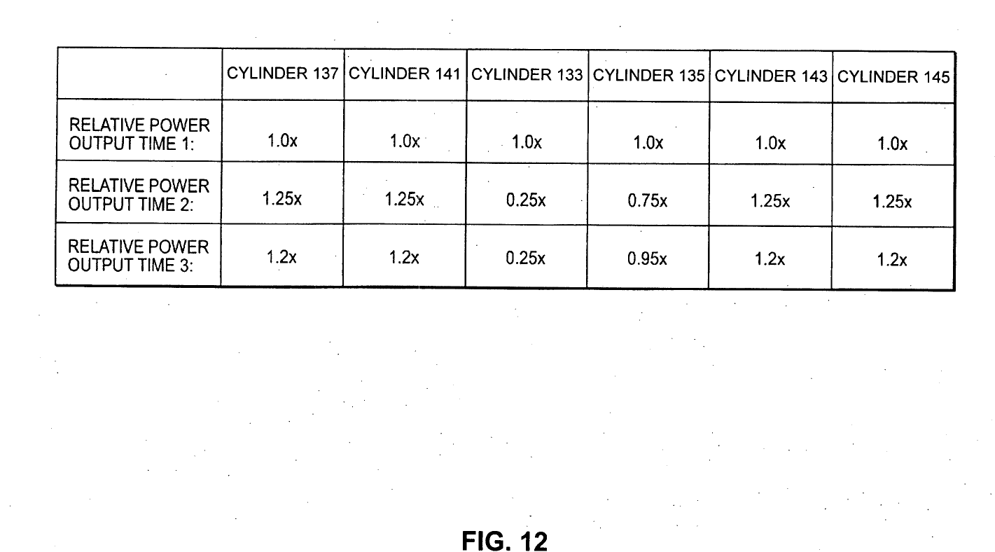

In one embodiment, the power outputs of each cylinder of power source 115 may be controlled during operation of power source 115. FIG. 12 illustrates exemplary power outputs of each of the cylinders of power source 115. In this embodiment, the power output of each of the cylinders of power source 115 may be expressed as a relative power output. The relative power output is a numeric value multiplied by a variable, in this case (x), wherein the total power output of power source 115 equals the number of cylinders multiplied by the variable, x. Therefore, in the embodiment of FIG. 12, where power source 115 includes six cylinders, the total power output of power source 115 may be expressed as 6x.

The variable, x, may be any power value. For example, x may be a number of horsepower (hp), watts, or foot-pounds per unit time. If, for example, the total power output of all the cylinders 133, 135, 137, 141, 143, 145 of power source 115 equals 30 hp, then x will equal 5 hp.

In one embodiment, illustrated at Time 1 in FIG. 12, the relative power output of each of the cylinders of power source 115, including single cylinder 133, cylinder 135, and all the other cylinders 137, 141, 143, 145 of second cylinder group 117, is approximately 1.0x. The. total power output of all the cylinders 133, 135, 137, 141, 143, 145 of power source 115, therefore, equals 6x. In this embodiment, the power output of power source 115 is distributed equally between each of the cylinders of power source 115.

In another embodiment, illustrated at Time 2 in FIG. 12, the relative power output of single cylinder 133 of first cylinder group 113 equals 0.25x, and the relative power output of cylinder 135 of second cylinder group 117 equals 0.75x. Further, the relative power output of all of the other cylinders 137, 141, 143, 145 is approximately 1.25x, and the total power output of all the cylinders 133, 135, 137, 141, 143, 145 of power source 115 equals 6x.

In yet another embodiment, illustrated at Time 3 in FIG. 12, the relative power output of single cylinder 133 of first cylinder group 113 equals 0.25x, and the relative power output of cylinder 135 of second cylinder group 117 equals 0.95x. Further, the relative power output of all of the other cylinders 137, 141, 143, 145 is approximately 1.2x, and the total power output of all the cylinders 133, 135, 137, 141, 143, 145 of power source 115 equals 6x.

The embodiments at Time 2 and Time 3 of FIG. 12 may allow power source 115 to operate with the minimum possible vibration, while also allowing the relative power outputs of the cylinders of power source 115 to be changed during operation. In these embodiments, matching of the stroke cycles of single cylinder 133 and cylinder 135 may allow these two cylinders to produce combined power and force similar to any one of the other cylinders 137, 141, 143, 145 of second cylinder group 117. Further, the force produced by single cylinder 133 and cylinder 135 may be balanced by the power and force of all the other cylinders 137, 141, 143, 145 of second cylinder group 117.

Controlling the power outputs of each of the cylinders of power source 115 may affect ammonia production, NOₓ emissions, maximum power output, and/or fuel efficiency. For example, when increased power output is needed, all cylinders of power source 115 may operate at maximum power. In another embodiment, the power output of any one of the one or more cylinders of first cylinder group 113 may be less than the power output of each of the cylinders of second cylinder group 117, as shown at Time 2 and Time 3 of FIG. 12. In this embodiment, first cylinder group 113 may produce less power, but the operation of first cylinder group 113 may be controlled to match ammonia production with NOₓ production from second cylinder group 117.

### INDUSTRIAL APPLICABILITY

During use, the internal combustion engine 110 may operate in a known manner using, for example, the diesel principle of operation. Referring to the exemplary air supply system shown in FIG. 1, exhaust gas from the internal combustion engine 110 is transported from the exhaust manifold 116 through the inlet duct 126 and impinges on and causes rotation of the turbine wheel 128. The turbine wheel 128 is coupled with the shaft 130, which in turn carries the compressor wheel 134. The rotational speed of the compressor wheel 134 thus corresponds to the rotational speed of the shaft 130.

The exemplary fuel supply system 200 and cylinder 112 shown in FIG. 2 may be used with each of the exemplary air supply systems 100, 300, 400 (and with the power source 115). Compressed air is supplied to the combustion chamber 206 via the intake port 208, and exhaust air exits the combustion chamber 206 via the exhaust port 210. The intake valve assembly 214 and the exhaust valve assembly 216 may be controllably operated to direct airflow into and out of the combustion chamber 206.

In a conventional Otto or diesel cycle mode, the intake valve 218 moves from the second position to the first position in a cyclical fashion to allow compressed air to enter the combustion chamber 206 of the cylinder 112 at near top center of the intake stroke 406 (about 360° crank angle), as shown in FIG. 4. At near bottom dead center of the compression stroke (about 540° crank angle), the intake valve 218 moves from the first position to the second position to block additional air from entering the combustion chamber 206. Fuel may then be injected from the fuel injector assembly 240 at near top dead center of the compression stroke (about 720° crank angle).

In a conventional Miller cycle engine, the conventional Otto or diesel cycle is modified by moving the intake valve 218 from the first position to the second position at either some predetermined time before bottom dead center of the intake stroke 406 (i.e., before 540° crank angle) or some predetermined time after bottom dead center of the compression stroke 407 (i.e., after 540° crank angle). In a conventional late-closing Miller cycle, the intake valve 218 is moved from the first position to the second position during a first portion of the first half of the compression stroke 407.

The variable intake valve closing mechanism 238 enables the engine 110 to be operated in both a late-closing Miller cycle and a conventional Otto or diesel cycle, and possibly even an early-closing Miller cycle, e.g., when the cam 234 is configured to cause cyclical closure of intake valve 218 prior to bottom dead center during the intake stroke. Further, injecting a substantial portion of fuel after top dead center of the combustion stroke 508, as shown in FIG. 5, may reduce NOₓ emissions and increase the amount of energy rejected to the exhaust manifold 116 in the form of exhaust fluid. Use of a high-efficiency turbocharger 320, .420 or series turbochargers 120, 140 may enable recapture of at least a portion of the rejected energy from the exhaust. The rejected energy may be converted into increased air pressures delivered to the intake manifold 114, which may increase the energy pushing the piston 212 against the crankshaft 213 to produce useable work. In addition, delaying movement of the intake valve 218 from the first position to the second position may reduce the compression temperature in the combustion chamber 206. The reduced compression temperature may further reduce NOₓ emissions.

The controller 244 may operate the variable intake valve closing mechanism 238 to vary the timing of the intake valve assembly 214 to achieve desired engine performance based on one or more engine conditions, for example, engine speed, engine load, engine temperature, boost, and/or manifold intake temperature. The variable intake valve closing mechanism 238 may also allow more precise control of the air/fuel ratio. By delaying closing of the intake valve assembly 214, the controller 244 may control the cylinder pressure during the compression stroke of the piston 212. For example, late closing of the intake valve reduces the compression work that the piston 212 must perform without compromising cylinder pressure and while maintaining a standard expansion ratio and a suitable air/fuel ratio.

The high pressure air provided by the exemplary air supply systems 100, 300, 400 may provide extra boost on the induction stroke of the piston 212. The high pressure may also enable the intake valve assembly 214 to be closed even later than in a conventional Miller cycle engine. For example, the intake valve assembly 214 may remain open until the second half of the compression stroke of the piston 212, for example, as late as about 80° to 70° before top dead center (BTDC). While the intake valve assembly 214 is open, air may flow between the chamber 206 and the intake manifold 114. Thus, the cylinder 112 may experience less of a temperature rise in the chamber 206 during the compression stroke of the piston 212.

Since the closing of the intake valve assembly 214 may be delayed, the timing of the fuel supply system may also be retarded. For example, the controller 244 may controllably operate the fuel injector assembly 240 to supply fuel to the combustion chamber 206 after the intake valve assembly 214 is closed. For example, the fuel injector assembly 240 may be controlled to supply a pilot injection of fuel contemporaneous with or slightly after the intake valve assembly 214 is closed and to supply a main injection of fuel contemporaneous with or slightly before combustion temperature is reached in the chamber 206. As a result, a significant amount of exhaust energy may be available for recirculation by the air supply system 100, 300, 400, which may efficiently extract additional work from the exhaust energy.

Although some examples described herein involve late intake valve closure, it should be understood that certain examples in accordance with the invention might involve engine operation where both late and early intake valve closure is selectively provided, or engine operation where only early intake valve closure is selectively provided. For example, in some exemplary engines including a camshaft 232, the cams 234 could have an alternative profile providing cyclical early intake valve closure and the variable intake valve closing mechanism 238 may be controlled to selectively delay the intake valve closing so that the delayed intake valve closing occurs before, at, and/or after bottom dead center of the intake stroke.

Referring to the exemplary air supply system 100 of FIG. 1, the second turbocharger 140 may extract otherwise wasted energy from the exhaust stream of the first turbocharger 120 to turn the compressor wheel 150 of the second turbocharger 140, which is in series with the compressor wheel 134 of the first turbocharger 120. The extra restriction in the exhaust path resulting from the addition of the second turbocharger 140 may raise the back pressure on the piston 212. However, the energy recovery accomplished through the second turbocharger 140 may offset the work consumed by the higher back pressure. For example, the additional pressure achieved by the series turbochargers 120, 140 may do work on the piston 212 during the induction stroke of the combustion cycle. Further, the added pressure on the cylinder resulting from the second turbocharger 140 may be controlled and/or relieved by using the late intake valve closing. Thus, the series turbochargers 120, 140 may provide fuel efficiency via the air supply system 100, and not simply more power.

It should be appreciated that the air cooler 156, 356, 456 preceding the intake manifold 114 may extract heat from the air to lower the inlet manifold temperature, while maintaining the denseness of the pressurized air. The optional additional air cooler between compressors or after the air cooler 156, 356, 456 may further reduce the inlet manifold temperature, but may lower the work potential of the pressurized air. The lower inlet manifold temperature may reduce the NOₓ emissions.

Referring again to FIG. 8, a change in pressure of exhaust gases passing through the PM filter 806 results from an accumulation of particulate matter, thus indicating a need to regenerate the PM filter 806, i.e., burn away the accumulation of particulate matter. For example, as particulate matter accumulates, pressure in the PM filter 806 increases.

The PM filter 806 may be a catalyzed diesel particulate filter (CDPF) or an active diesel particulate filter (ADPF). A CDPF allows soot to burn at much lower temperatures. An ADPF is defined by raising the PM filter internal energy by means other than the engine 110, for example electrical heating, burner, fuel injection, and the like.

One method to increase the exhaust temperature and initiate PM filter regeneration is to use the throttle valve 814 to restrict the inlet air, thus increasing exhaust temperature. Other methods to increase exhaust temperature include variable geometry turbochargers, smart wastegates, variable valve actuation, and the like. Yet another method to increase exhaust temperature and initiate PM filter regeneration includes the use of a post injection of fuel, i.e., a fuel injection timed after delivery of a main injection.

The throttle valve 814 may be coupled to the EGR valve 812 so that they are both actuated together. Alternatively, the throttle valve 814 and the EGR valve 812 may be actuated independently of each other. Both valves may operate together or independently to modulate the rate of EGR being delivered to the intake manifold 114.

CDPFs regenerate more effectively when the ratio of NOₓ, to particulate matter, i.e., soot, is within a certain range, for example, from about 20 to 1 to about 30 to 1. In some examples, an EGR system combined with the above described methods of multiple fuel injections and variable valve timing may result in a NOₓ, to soot ratio of about 10 to 1. Thus, it may be desirable to periodically adjust the levels of emissions to change the NOₓ, to soot ratio to a more desired range and then initiate regeneration. Examples of methods which may be used include adjusting the EGR rate and adjusting the timing of main fuel injection.

A venturi (not shown) may be used at the EGR entrance to the fresh air inlet. The venturi would depress the pressure of the fresh air at the inlet, thus allowing EGR to flow from the exhaust to the intake side. The venturi may include a diffuser portion which would restore the fresh air to near original velocity and pressure prior to entry into compressor 144. The use of a venturi and diffuser may increase engine efficiency.

An air and fuel supply system for an internal combustion engine in accordance with the exemplary embodiments of the invention may extract additional work from the engine's exhaust. The system may also achieve fuel efficiency and reduced NOₓ, emissions, while maintaining work potential and ensuring that the system reliability meets with operator expectations.

The present disclosure further provides an exhaust-gas purification system including a power source with on-board ammonia production. This purification system may be useful in all engine types that produce NOₓ emissions.

The power source of the present disclosure provides a method for improved control of ammonia production, power output, and NOₓ emissions. The power source includes first and second cylinder groups with fluidly isolated air-intake passages. The fluidly isolated air-intake passages may be connected to separate forced-induction systems to rapidly change air-intake in either one or both of the cylinder groups. Further, in order to increase ammonia production, one cylinder group may operate under lean conditions, and fuel may be injected into the NOₓ-containing exhaust gas to produce a rich, NOₓ-containing exhaust that may be converted to ammonia for use with SCR systems.

In addition, the present disclosure provides a method for reducing engine vibrations due to differences in power output of individual engine cylinders. The method includes matching the cylinder stroke cycles of two or more cylinders so that these cylinders may function as a single cylinder. Matching of stroke cycles in this way may reduce engine vibrations by balancing power output and vibrations of each engine cylinder. This method may also allow low engine vibration, while operating the engine at different load levels.

It will be apparent to those skilled in the art that various modifications and variations can be made to the subject matter disclosed herein without departing from the invention. Other embodiments of the invention will be apparent to those skilled in the art from consideration of the specification and practice of the invention disclosed herein. It is intended that the specification and examples be considered as exemplary only.

1. A method of operating an internal combustion engine including at least one cylinder and a piston slidable in the cylinder, the method comprising:
supplying pressurized air from an intake manifold to an air intake port of a combustion chamber in the cylinder;
operating an air intake valve to open the air intake port to allow pressurized air to flow between the combustion chamber and the intake manifold substantially during a majority portion of a compression stroke of the piston; and
converting at least a portion of combustion exhaust into ammonia.

2. The method of claim 1, wherein said operating includes operating a variable intake valve closing mechanism to keep the intake valve open.

3. The method of claim 1, wherein the operation of the air intake valve is based on at least one engine condition.

4. The method of claim 1, further including controlling a fuel supply system to inject fuel into the combustion chamber.

5. The method of claim 4, further including injecting at least a portion of the fuel during a portion of the compression stroke.

6. The method of claim 5, wherein injecting at least a portion of the fuel includes supplying a pilot injection at a predetermined crank angle before a main injection.

7. The method of claim 1, further including cooling the pressurized air prior to supplying the pressurized air to the air intake port.

8. The method of claim 1, wherein said supplying includes supplying a mixture of pressurized air and recirculated exhaust gas from the intake manifold to the air intake port, and wherein said operating includes operating the air intake valve to open the air intake port to allow the pressurized air and exhaust gas mixture to flow between the combustion chamber and the intake manifold substantially during a majority portion of the compression stroke of the piston.

9. The method of claim 8, wherein said supplying a mixture of pressurized air and recirculated exhaust gas includes providing a quantity of exhaust gas from an exhaust gas recirculation (EGR) system.

10. The method of claim 1 reacting the ammonia and exhaust gas via a NOₓ-reducing catalyst.

11. The method of claim 1, wherein said converting includes reacting combustion exhaust from lean combustion via an ammonia-producing catalyst.

12. The method of claim 11, further including supplying fuel to the combustion exhaust from lean combustion.

13. An internal combustion engine, comprising:
an engine block defining at least one cylinder;
a head connected with said engine block, the head including an air intake port, and an exhaust port;
a piston slidable in the cylinder;
a combustion chamber being defined by said head, said piston, and said cylinder;
an air intake valve movable to open and close the air intake port;
an air supply system including at least one turbocharger fluidly connected to the air intake port;
a fuel supply system operable to inject fuel into the combustion chamber; and
an ammonia-producing catalyst arranged to convert at least a portion of combustion exhaust into ammonia;
wherein the engine is configured to operate the air intake valve so as to vary the closing time of the air intake valve.

14. The engine of claim 13, wherein the engine is configured to keep the intake valve open during a portion of a compression stroke of the piston.

15. The engine of claim 14, wherein the engine is configured to keep the intake valve open for a portion of a second half of the compression stroke.

16. The engine of claim 13, wherein the engine is configured to close the intake valve before bottom dead center of an intake stroke of the piston.

17. The engine of claim 13, further including an air intake valve assembly and a variable intake valve mechanism, the air intake valve assembly being connected with said intake valve, said air intake valve assembly adapted to cyclically move said intake valve, and said variable intake valve mechanism being configured to interrupt cyclical movement of the intake valve.

18. The engine of claim 17, wherein said air intake valve assembly includes a cam.

19. The engine of claim 13, wherein the at least one turbocharger includes a first turbine coupled with a first compressor, the first turbine being in fluid communication with the exhaust port, the first compressor being in fluid communication with the air intake port; and wherein the air supply system further includes a second compressor being in fluid communication with atmosphere and the first compressor.

20. The engine of claim 13, wherein the at least one turbocharger includes a first turbocharger and a second turbocharger, the first turbocharger including a first turbine coupled with a first compressor, the first turbine being in fluid communication with the exhaust port and an exhaust duct, the first compressor being in fluid communication with the air intake port, the second turbocharger including a second turbine coupled with a second compressor, the second turbine being in fluid communication with the exhaust duct of the first turbocharger and atmosphere, and the second compressor being in fluid communication with atmosphere and the first compressor.

21. The engine of claim 13, further including an exhaust gas recirculation (EGR) system operable to provide a portion of exhaust gas from the exhaust port to the air supply system.

22. The engine of claim 13, further including a NOₓ-reducing catalyst configured to react the ammonia and exhaust gas.

23. The engine of claim 13, wherein the engine includes a plurality of cylinders, and wherein the engine is configured to have lean combustion in at least one of the cylinders and direct exhaust of the lean combustion to the ammonia-producing catalyst.

24. A method of operating an internal combustion engine including at least one cylinder and a piston slidable in the cylinder, the method comprising:
imparting rotational movement to a first turbine and a first compressor of a first turbocharger with exhaust air flowing from an exhaust port of the cylinder; imparting rotational movement to a second turbine and a second compressor of a second turbocharger with exhaust air flowing from an exhaust duct of the first turbocharger;
compressing air drawn from atmosphere with the second compressor;
compressing air received from the second compressor with the first compressor;
supplying pressurized air from the first compressor to an air intake port of a combustion chamber in the cylinder via an intake manifold;
operating a fuel supply system to inject fuel directly into the combustion chamber;
operating an air intake valve to open the air intake port to allow pressurized air to flow between the combustion chamber and the intake manifold; and
converting at least a portion of combustion exhaust into ammonia.

25. The method of claim 24, wherein fuel is injected during a combustion stroke of the piston.

26. The method of claim 25, wherein fuel injection begins during a compression stroke of the piston.

27. The method of claim 24, wherein said operating of the air intake valve includes operating the air intake valve to open the air intake port to allow pressurized air to flow between the combustion chamber and the intake manifold during a portion of a compression stroke of the piston.

28. The method of claim 27, wherein said operating of the air intake valve includes operating the intake valve to remain open for a portion of a second half of a compression stroke of the piston.

29. The method of claim 24, wherein said operating of the air intake valve includes operating the intake valve to close the intake valve before bottom dead center of an intake stroke of the piston.

30. The method of claim 24, further including cyclically moving the intake valve, wherein said operating of the air intake valve includes interrupting cyclical movement of the intake valve.

31. The method of claim 24, wherein the operation of the air intake valve is based on at least one engine condition.

32. The method of claim 24, wherein said first and second compressors compress a mixture of air and recirculated exhaust gas, and wherein said supplying includes supplying the compressed mixture of pressurized air and recirculated exhaust gas to said intake port via said intake manifold.

33. The method of claim 24, reacting the ammonia and exhaust gas via a NOₓ-reducing catalyst.

34. The method of claim 24, wherein said converting includes reacting combustion exhaust from lean combustion via an ammonia-producing catalyst.

35. The method of claim 34, further including supplying fuel to the combustion exhaust from lean combustion.

36. A method of controlling an internal combustion engine having a variable compression ratio, said engine including a block defining a cylinder, a piston slidable in said cylinder, and a head connected with said block, said piston, said cylinder, and said head defining a combustion chamber, the method comprising:
pressurizing air;
supplying said air to an intake manifold of the engine;
maintaining fluid communication between said combustion chamber and the intake manifold during a portion of an intake stroke and through a portion of a compression stroke;
injecting fuel directly into the combustion chamber; and
converting at least a portion of combustion exhaust into ammonia.

37. The method of claim 36, wherein said injecting fuel includes injecting fuel directly to the combustion chamber during a portion of a combustion stroke of the piston.

38. The method of claim 36, wherein said injecting fuel includes injecting fuel directly to the combustion chamber during a portion of the compression stroke.

39. The method of claim 36, wherein said injecting includes supplying a pilot injection at a predetermined crank angle before a main injection.

40. The method of claim 36, wherein said portion of the compression stroke is at least a majority of the compression stroke.

41. The method of claim 36, wherein said pressurizing includes a first stage of pressurization and a second stage of pressurization.

42. The method of claim 41, further including cooling air between said first stage of pressurization and said second stage of pressurization.

43. The method of claim 36, further including cooling the pressurized air.

44. The method of claim 36, wherein the pressurizing includes pressurizing a mixture of air and recirculated exhaust gas, and wherein the supplying includes supplying the pressurized air and exhaust gas mixture to the intake manifold.

45. The method of claim 44, further including cooling the pressurized air and exhaust gas mixture.

46. The method of claim 36, further including hydraulically holding an air intake valve open during at least part of the portion of the compression stroke.

47. The method of claim 36, further including varying closing time of an intake valve so that a duration of said portion of the compression stroke differs in multiple compression strokes of the piston.

48. The method of claim 36, reacting the ammonia and exhaust gas via a NOₓ-reducing catalyst.

49. The method of claim 36, wherein said converting includes reacting combustion exhaust from lean combustion via an ammonia-producing catalyst.

50. The method of claim 49, further including supplying fuel to the combustion exhaust from lean combustion.

51. A method of generating an internal combustion engine including at least one cylinder and a piston slidable in the cylinder, the method comprising:
supplying pressurized air from an intake manifold to an air intake port of a combustion chamber in the cylinder;
operating an air intake valve to open the air intake port to allow pressurized air to flow between the combustion chamber and the intake manifold substantially during a portion of a compression stroke of the piston;
injecting fuel into the combustion chamber after the intake valve is closed, wherein the injecting includes supplying a pilot injection of fuel at a crank angle before a main injection of fuel; and
converting at least a portion of combustion exhaust into ammonia.

52. The method of claim 51, wherein said operating includes operating a variable intake valve closing mechanism to keep the intake valve open.

53. The method of claim 51, wherein at least a portion of the main injection occurs during a combustion stroke of the piston.

54. The method of claim 51, further including cooling the pressurized air prior to supplying the pressurized air to the air intake port.

55. The method of claim 51, wherein said supplying includes supplying a mixture of pressurized air and recirculated exhaust gas from the intake manifold to the air intake port, and wherein said operating includes operating the air intake valve to open the air take port to allow the pressurized air and exhaust gas mixture to flow between the combustion chamber and the intake manifold substantially during a portion of the compression stroke of the piston.

56. The method of claim 55, wherein said supplying a mixture of pressurized air and recirculated exhaust gas includes providing a quantity of exhaust gas from an exhaust gas recirculation (EGR) system.

57. The method of claim 51, reacting the ammonia and exhaust gas via a NOₓ-reducing catalyst.

58. The method of claim 51, wherein said converting includes reacting combustion exhaust from lean combustion via an ammonia-producing catalyst.

59. The method of claim 58, further including supplying fuel to the combustion exhaust from lean combustion.
